(19) United States
(12) Patent Application Publication
(10) Pub. No.: US 2023/0008972 A1
(43) Pub. Date: Jan. 12, 2023

(54) APPARATUS AND A METHOD FOR BUOYANT ELEVATION OF A MASS

(71) Applicant: MYSORE VISHWAMITHRA VENKATARAMAIAH, Bangalore (IN)

(72) Inventor: VISHWAMITHRA VENKATARAMAIAH MYSORE, BANGALORE (IN)

(21) Appl. No.: 17/784,668

(22) PCT Filed: Jan. 9, 2021
(86) PCT No.: PCT/IN2021/050024

§ 371 Date: Jun. 13, 2022

(30) Foreign Application Priority Data
Nov. 25, 2020 (IN) 202041051360

(51) Int. Cl. F03B 17/04

(52) U.S. Cl. CPC F03B 17/04

(57) ABSTRACT

An apparatus for elevation of a plurality of buoyant masses is disclosed. The apparatus comprising a plurality of stacked fluid chambers. Each of the plurality of stacked fluid chambers is pre-filed with a fluid. A plurality of buoyant masses disposed within the plurality of stacked fluid chambers. The plurality of buoyant masses is displaced from one chamber to other due to buoyancy thereof, the plurality of buoyant masses being displaced through the fluid within the plurality of stacked fluid chambers. When the apparatus is primed and activated, one of the buoyant mass is lifted up from one chamber to another chamber. This up lifted buoyant mass can be used to generated electricity by tapping kinetic energy from the up lifted buoyant mass.

### FIELD OF THE INVENTION

The present disclosure generally relates to energy generation and more specifically to an apparatus and a method for buoyant elevation of a given mass which may be employed for energy generation and working in a cyclic continuous manner.

### TECHNICAL BACKGROUND

Demand for energy is increasing with the world's swelling population and urbanisation. At present the world's energy demand is fulfilled mostly by using the non-renewable energy resources which include oil, coal, natural gas, and nuclear energy. These non-renewable energy resources do present with grave environment problems and hazards. For example, the non-renewable energy resources such as oil, coal, and natural gas though very useful, generate toxic and/or hazardous gases which pollutes the environment, and causes problems for humans, animals, and plants. Similar issues are encountered with the use of nuclear energy.

Accordingly, there is a need to provide sustainable energy resources, which are both renewable and environmentally friendly and work towards achieving at least one of the following:
a. Small reduction in world carbon foot print;
b. Small reduction in global warming; and
c. Small reduction in rapid melting of Artic and Antarctic Ice followed by small reduction in rise of increasing sea level.

### BRIEF SUMMARY OF TIFF INVENTION

An object of the present disclosure is to provide an alternative energy source which is renewable and environmentally friendly.

The present disclosure provides an apparatus and a method for elevation of buoyant mass for generating energy.

In one aspect an apparatus is disclosed. The apparatus comprising a plurality of stacked fluid chambers, the plurality of stacked fluid chambers being stacked one above the other. Each of the plurality of stacked fluid chambers is pre-filled with a fluid (by one time priming) and is configured to displace a buoyant mass upwards from at least one chamber of the plurality of stacked fluid chambers to other chambers of the plurality of stacked fluid chambers. Though plurality of buoyant mass is subjected to atmospheric pressure, impact of atmospheric pressure is negated by the fluid in plurality of stack fluid chambers and reduction of specific gravity of the buoyant mass to the extent of the atmospheric pressure. If specific gravity of buoyant mass is reduced to the extent of the fluid displaced by atmospheric pressure of 1 bar, the buoyant mass is free from any gravitational forces which can be termed as the elevation process.

Further, the plurality of stacked buoyant masses is disposed in the at least one chamber of the plurality of stacked fluid chambers, wherein the at least one of the plurality of stacked buoyant masses is configured to move upwards from the at least one chamber of the up by passing through plurality of stacked fluid chambers to the other chambers of the plurality of stacked fluid chambers, through the fluid.

The atmospheric pressure acting at bottom of the stack of each of the plurality of stacked fluid chambers displaces the fluid from the plurality of stacked fluid chambers, and ensures that the fluid column in the chamber is intact as inside of the plurality of stacked fluid chambers and further is not exposed to atmospheric pressure. Still further, the fluid is prevented form draining out of the plurality of stacked fluid chambers to other chambers as vacuum is generated which avoids draining of the plurality of stacked fluid chambers based on the atmospheric pressure acting on the fluid contained in each of the plurality of stacked fluid chambers.

In an operative configuration, when the apparatus is fully primed and activated, the at least one of the bottom most of the plurality stacked buoyant masses which is at zero kinetic energy level is lifted up at least for a first kinetic energy from the at least one chamber of the plurality of stacked fluid chambers, and up lifted by at least one of height of single buoyant mass. This herein is termed as unit lift.

Since all the buoyant masses are stacked or cohesive one after the other, unit lift at bottom results in unit lift of one buoyant mass on the top of the top most of the plurality of stacked fluid chambers. In a scale of 0 to 10, this position herein is referred to as a position at kinetic energy level 10, wherein the kinetic energy level 10 is higher than the kinetic energy level 0.

During this unit lift of the buoyant mass disposed within the plurality of stacked fluid chambers due to the buoyant force of the fluid appear to have reduced mass, and further the fluid surrounding the buoyant mass functions as a lubricant and ensures that there is little or no resistance to an operative upward movement of the buoyant mass through the plurality of stacked fluid chambers.

In accordance with an embodiment of the present invention the apparatus is primed, the priming of the apparatus may be done by one of the mechanical priming or electronic priming. The priming includes the following steps, pre-filling the plurality of stacked fluid chambers with the buoyant mass, or at least the buoyant masses are placed in an isolator, while rest of the buoyant masses being disposed within the plurality of stacked fluid chambers after fluid priming, filling a fluid container with the fluid, wherein the vertical level of which is higher than bottom of a fluid retaining tube, closing a bottom face of the fluid retaining tube temporarily using a lid and a seal to prevent leakage of the fluid, fixing a threaded bleed screw with seal on top left corner of the fluid retaining tube, wherein the threaded bleed screw facilitates in venting out the air trapped inside the fluid retaining tube, a port plug is provided on the top right corner of the fluid retaining tube which is opened and the fluid is filled in therethrough, filling the fluid retaining tube completely with the fluid, closing the threaded bleed screw with the seal, and the port plug and opening the bottom lid, which establishes the priming process.

Further at kinetic energy level up to level 10, the plurality of stacked buoyant masses reaches the other chambers of the plurality of stacked fluid chambers at a second kinetic energy, wherein the second kinetic energy is higher than the first kinetic energy.

At kinetic energy level 10, the plurality of stacked buoyant masses is gravity fed one by one over a slant bed to an electricity generation unit to generate electric power. After travelling through the slant bed, the kinetic energy level of the buoyant masses drops to the extent of height of the slant bed thus reducing buoyant masses kinetic energy level from 10 to 9.

Further, the buoyant mass at the Kinetic energy level 9 is guided and made to travel through a conveyor of generation unit, wherein most of the kinetic energy is absorbed by the generator to produce useful electric power. Electric generator and its capacity and its frictional losses are designed in such a way that the buoyant masses after descendance still have residue kinetic energy level and this level herein is termed as Kinetic energy level 1,

At Kinetic energy level 9, the freely falling plurality of buoyant masses have potential to drop because of the gravitational force at a speed of 9.8 meters per second square. But instead of free fall, the plurality of buoyant masses are made to travel through the conveyor of generation unit (with load condition) wherein most of the kinetic energy of the buoyant masses is absorbed by the generator unit so as to produce useful electricity, which results in decrease of the kinetic energy of the buoyant masses from level 9 to 1. After completion of travel through the electric generator and at kinetic energy level 1, the travelling speed of the plurality of buoyant masses cannot be zero as the system has to continuously run and at this level travelling speed of the buoyant masses can be designed to be less than 1 meters per second so that maximum amount of the travelling speed can be absorbed by the electric generator. This reduced speed of less than 1 meter per second, is the designated speed of buoyant mass with load (because of generator running) and is applied uniformly throughout the system including the speed of buoyant masses first push from bottom of fluid chamber.

In other words, upon generation of the electric power, the buoyant masses reach the third kinetic energy level which is lesser than the second kinetic energy level. In particular, the second kinetic energy level is at scale 9, whereas the third kinetic energy level can be at scale 1.

At Kinetic energy level-1, which is at bottom of generator conveyor, a buoyant mass holder (guiding chamber) coupled to a transfer mechanism is placed. This buoyant mass holder is configured to receive the buoyant mass at kinetic energy level 1 (in air media) in a disciplined sequence and passed through the fluid media so as to finally make it reach the fluid chamber bottom by spending very small amount of energy, thus completing 1 cycle of motion.

A method, comprising disposing a plurality of stacked fluid chambers, filling each of the plurality of stacked fluid chambers with a displaceable fluid, wherein each of the plurality of stacked fluid chambers is configured to displace a plurality of stacked buoyant masses from at least one chamber of the plurality of stacked fluid chambers to other chambers of the plurality of stacked fluid chambers, wherein the plurality of stacked buoyant masses are disposed within the at least one chamber of the plurality of stacked fluid chambers, through the fluid, wherein, when activated, the at least one of the plurality of stacked buoyant masses are pumped with a first kinetic energy from the at least one chamber of the plurality of stacked fluid chambers, and the pumped at least one of the plurality of stacked buoyant masses reaches the other chambers of the plurality of stacked fluid chambers at a second kinetic energy, wherein the second kinetic energy is higher than the first kinetic energy, wherein the second kinetic energy is at scale 10, and the first kinetic energy is at scale 0.

### BRIEF DESCRIPTION OF THE DRAWING

The present disclosure will now be described with the help of accompanying drawing, in which:

FIG. 1 illustrates a schematic diagram of an apparatus for buoyant elevation of a mass for generating electricity in accordance with the embodiments of the present disclosure.

FIG. 2 illustrates a schematic diagram of an isolator (barrier gadget for fluid separation between chambers) which forms a part of the apparatus for buoyant elevation of a mass in accordance with the embodiments of the present disclosure.

FIG. 3 illustrates a schematic diagram of an apparatus for buoyant elevation of a mass for generating electricity (in addition to buoyant elevation of a mass shown in FIG. 1), in accordance with the embodiments of the present disclosure.

FIG. 4A, FIG. 4B, FIG. 4C, and FIG. 4D illustrate a schematic diagram of priming process in accordance with the embodiments of the present disclosure.

### DETAILED DESCRIPTION OF THE INVENTION

All the terms and expressions, which may be technical, scientific, or otherwise, as used in the present disclosure have the same meaning as understood by a person having ordinary skill in the art to which the present disclosure belongs, unless and otherwise explicitly specified.

In the present disclosure, and the claims, the articles “a”, “an”, and “the” include plural references unless the context clearly dictates otherwise.

The term “comprising” as used in the present disclosure and the claims will be understood to mean that the list following is non-exhaustive and may or may not include any other extra suitable features or elements or steps or constituents as applicable.

The present disclosure relates to an apparatus and a method for buoyant elevation of a buoyant mass which may be employed for energy generation, and which overcomes one or more drawbacks associated with the prior art.

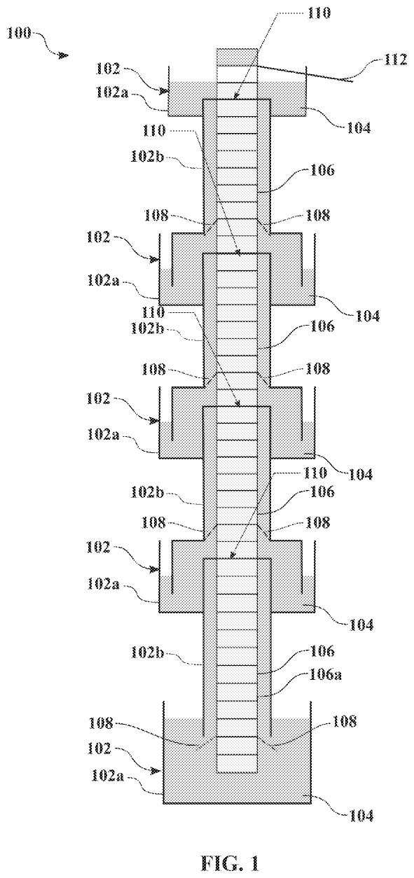

In an aspect an apparatus 100 is disclosed. FIG. 1 illustrates a schematic diagram of the apparatus 100 for buoyant elevation of a buoyant mass in accordance with the embodiments of the present disclosure. The apparatus 100 comprising a plurality of stacked fluid chambers 102 filled with a fluid 104, and a plurality of stacked buoyant masses 106 disposed in all the chambers 102 of the plurality of stacked fluid chambers 102.

The plurality of stacked fluid chambers 102 is configured to displace the plurality of stacked buoyant masses 106 from at least one chamber of the plurality of stacked fluid chambers 102 to other chambers of the plurality of stacked fluid chambers 102 during priming process.

Each of the chamber of the plurality of stacked fluid chambers 102 comprises a fluid container 102a and a fluid retaining tube 102b, wherein the fluid retaining tube 102b is held such that an end of the fluid retaining tube 102b is immersed in the fluid contained within the fluid container 102a, thereby establishing a barometric configuration by employing a suitable supporting structure (not shown in the figure).

Till the implementation of the priming process, all the fluid 104 contained in the fluid container 102a and the fluid retaining tube 102b is exposed to atmospheric pressure. After the implementation of the priming process, an operative top of the fluid retaining tube 102b is sealed (using a screw/plug or stop valve, arrangement of which is not explicitly shown the figure) and a lid 113 at bottom of the fluid retaining tube 102b is released (lid arrangement of which is not explicitly shown the figure).

After implementation of the priming process and establishing arrangement of the fluid retaining tube 102b (which is similar to or closely resembles a barometer), the fluid in the fluid retaining tube 102b continues to be in elevated position as the same is not exposed to atmospheric pressure. The fluid contained in the fluid container 102a continues to get exposed/free from atmospheric pressure to atmospheric pressure and hence this position, the fluid level continues to be static.

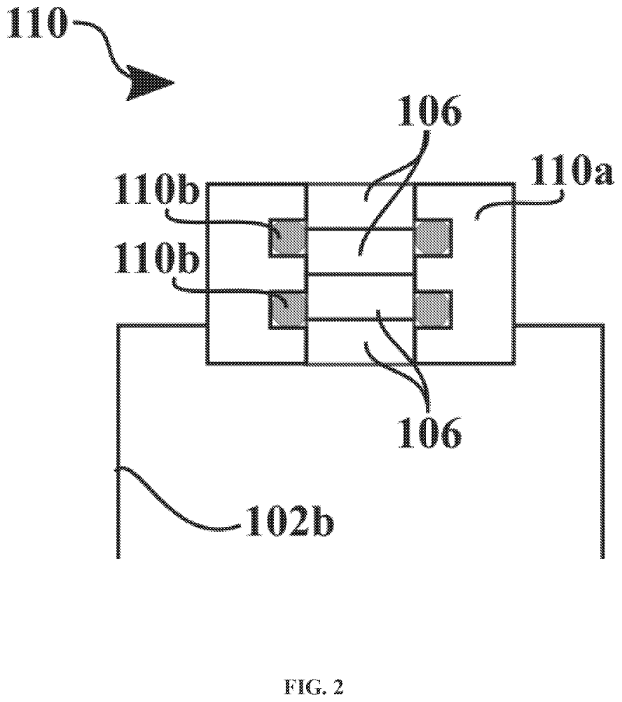

Each of the chamber of the plurality of stacked fluid chambers 102 are isolated by an isolator arrangement 110 as shown in FIG. 2 and using flexible sealing element 110b. Details are shown in FIG. 2. The flexible sealing element 110b is housed in grooves located in a housing 110a.

Each of the plurality of stacked fluid chambers 102 are vertically arranged above each other such that a first chamber of the plurality of stacked fluid chambers 102 is disposed at a first altitude level and a second chamber is disposed at a second altitude level, wherein the second altitude level is higher than the first altitude level.

In accordance with one embodiment, the number of chambers is four. In another embodiment the number of chambers can be more or less than four and is not limited to four. The number of chambers that are stacked and the height of each chamber depends on the fluid used, its density and the altitude at which the apparatus is deployed. In one embodiment, the chamber of the plurality of stacked fluid chambers 102 has a height of 9 meters each. In another embodiment, the height can be 8 meters. If the apparatus is installed at sea level, each fluid chamber can be as high as 10.3 meters if specific gravity of fluid is 1.0 (for example, the barometric height of water at sea level, the water being the fluid).

In one embodiment, the dimensions of the fluid retaining tube 102b can be chosen such that the plurality of stacked buoyant masses 106 can be displaced with minimum friction through the fluid retaining tube 102b.

In one embodiment, the fluid contained within the fluid container 102a and the fluid retaining tube 102b is water.

In one embodiment, the material of make of the chambers 102 can be any material that can withstand the fluid weight and can be supported by a suitable support structure. In one embodiment, the material of make is a metal, non-metal, plastic, and any combination thereof. In one embodiment the material can be a plastic. The chamber 102 can be cylindrical in shape. Any other shape is also well within the ambit of the present disclosure and the shape is not limited to cylindrical shape.

In one embodiment, each of the plurality of stacked buoyant masses 106 comprise a body 106a. The body 106a is a sealed hollow cylindrical body. The shape of the body 106a is not limited to the cylindrical and any other shape is also well within the ambit of the present disclosure and the shape is not limited to cylindrical shape. The buoyant mass 106 has a specific gravity (SG) which is less than that of the fluid employed. The buoyant mass's 106 shape, size, density, and specific gravity are chosen such that the buoyant mass 106, as the name indicates, floats on the fluid. In particular, when the buoyant masses 106 are introduced in the chambers 102 (as shown in the figures), the buoyant masses 106 experiences an upward buoyant force thereon and are urged upwards. In one embodiment, the specific gravity of the buoyant mass 106 is 0.99 or less. In another embodiment, the specific gravity of the buoyant mass 106 is less than 0.65. In yet another embodiment, the specific gravity of the buoyant mass 106 is less than 0.6.

Calculation of specific gravity of the buoyant mass 106. Take initial specific gravity (SG) of the buoyant mass to be less than specific gravity (SG) of the fluid. For example, the SG of the fluid is 1.0, then the SG of the buoyant mass is 0.99). Calculate the total mass of the plurality buoyant mass 106 required for filling the same in all fluid chambers (if 4 chambers are deployed having a height of 9 meters, total height shall be 9*4=36 meters). The total mass arrived such is called Initial mass.

Now, from this initial mass, reduce buoyant mass equivalent of 1 atmospheric pressure (mass of fluid column 10.3 meters if water) and derive at net mass. From this net mass, derive revised SG of the buoyant mass (if the height is 36-meter, SG will be around 0.60).

Take for example mass of fluid displaced by the plurality of buoyant mass is 1 Kgf, in each chamber. Total mass of water displaced is 4 Kgs. Initial mass will be 4*99%=3.96. If the atmospheric pressure is capable of displacing the fluid by one fluid chamber from top, recalculate the mass (4−1)*99%=2.97. Specific gravity of the buoyant mass 106 is 2.97/4=0.74. In addition to negating one atmospheric pressure as mentioned above, for effective running of apparatus it is recommended that the buoyant mass 106 shall have additional buoyancy by reduction of specific gravity of the buoyant mass 106 at least by another half (0.5) the height of one liquid chamber displayed by the buoyant mass. Hence, the recalculated SG (2.96−0.5)/4=0.615, say 0.60, which is applied to all buoyant masses 106 uniformly.

In one embodiment, the buoyant mass 106 has smooth edges which facilitate in easy stacking of the buoyant masses 106.

In one embodiment, the buoyant mass 106 includes a hollow cylindrical body made of plastic, wherein the hollow cylindrical body is sealed and encloses air therein, which affords the buoyant mass 106 the required buoyancy. In one embodiment the buoyant mass 106 can have a length (read height) in the range of 10 mm to 56 mm, and a diameter in the range of 65 mm to 250 mm. In one embodiment, the ratio of the diameter to length of the buoyant mass 106 can be in the range of 110% to 250%. In one embodiment the buoyant mass 106 can be a plastic hollow or even solid cylindrical body with an operative upper surface being concave and an operative lower surface thereof being convex or vice versa.

In one embodiment the upper surface can also be flat or convex or concave. In one embodiment, the buoyant mass 106 includes a relatively heavy base, and a relatively light top (if diameter of buoyant mass 106 is less than 110% of its height, such a configuration facilitates in retaining the buoyant mass 106 in upright position)

The apparatus 100 further includes a guiding member 108 operatively disposed in proximity of the open end of the fluid retaining tube 102b. The guiding member 108 can be supported suitably by the fluid retaining tube 102b or any other suitable supporting structure. In particular, the guiding member 108 is disposed between an inner wall of the fluid retaining tube 102b and the buoyant masses 106. In one embodiment, the guiding member 108 can be perforated or mesh type arrangement to facilitate free flow of the fluid through the fluid chamber 102. Each of the chambers of the plurality of stacked fluid chambers 102 includes at least one guiding member 108.

The apparatus 100 further includes an isolator 110 (see FIG. 2) operatively disposed between two consecutive chambers of the plurality of stacked fluid chambers 102. FIG. 2 illustrates a schematic diagram of the isolator 110 which forms a part of the apparatus 100 for buoyant elevation of a mass in accordance with the embodiments of the present disclosure. This isolator 110 comprise a chamber 110a having one or more grooves. These grooves are configured to receive one or more seals 110b as suitable. The seals 110b can be made of plasto-rubber or polytetrafluoroethylene (PTFE) or any other suitable sealing material. The seals 110b located in isolator 110 is deployed for retaining the fluid intact in each of the stacked fluid chambers 102 and avoid leakage of passage of fluid between the chamber. The coefficient of friction of seals 110b, can be least, say 0.10˜0.02 such that frictional losses in Kinetic energy elevation is kept at minimal and also can allow some small amount of fluid leakage through the chambers from top to bottom. Such leakages if any, shall be compensated by refilling of fluid 104 in top most container 102a from bottom most container 102b (arrangement of which is not shown explicitly in the drawing) Such energy/head loss of fluid 104 is minimal as compared to net output from the apparatus.

In an operative configuration, when the apparatus 100 is primed and activated, the at least one of the plurality of stacked buoyant masses 106 is lifted up, the plurality of stacked buoyant masses 106 being at zero kinetic energy level, from the at least one chamber of the plurality of stacked fluid chambers 102, and the uplifted buoyant masses 106 reach the other chambers of the plurality of stacked fluid chambers 102, at a kinetic energy level of ten, wherein the kinetic energy level of ten is higher than the zero kinetic energy level.

The kinetic energy of the buoyant masses 106 throughout the cycle (described herein) can be imagined to be at certain kinetic energy level. The kinetic energy of the buoyant masses 106 is attributed a scale starting at 0 and ending at 10, wherein scale 0 indicates least kinetic energy, and 10 indicates the highest kinetic energy. The scale of the kinetic energy is introduced to make the instant invention more evident and not to limit the scope thereof.

In accordance with the embodiments of the present invention, the apparatus 100 is primed that is made ready for operations. The process of priming is described herein below.

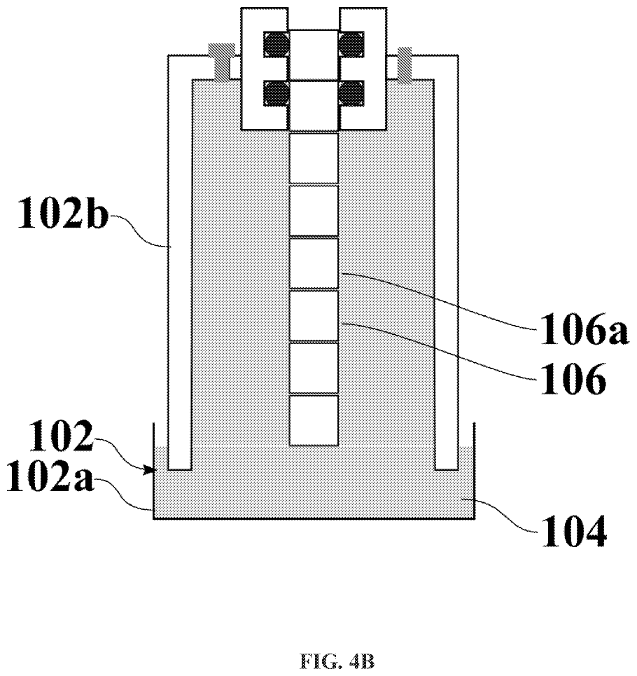

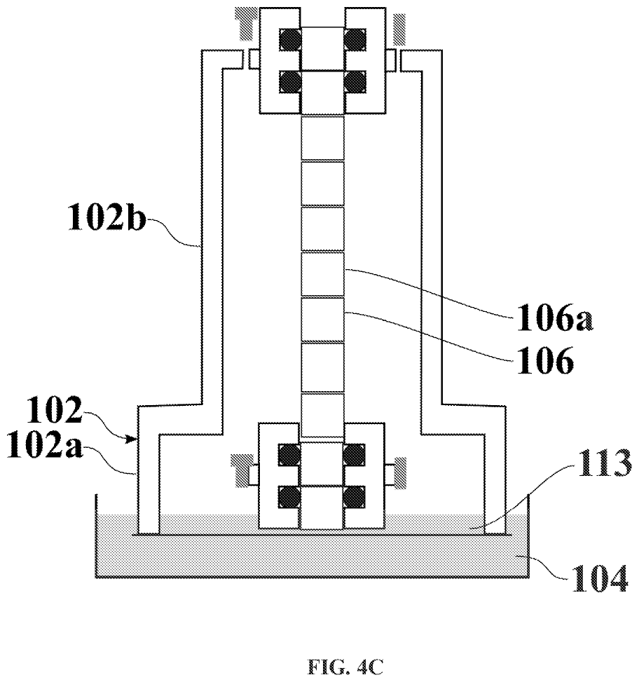

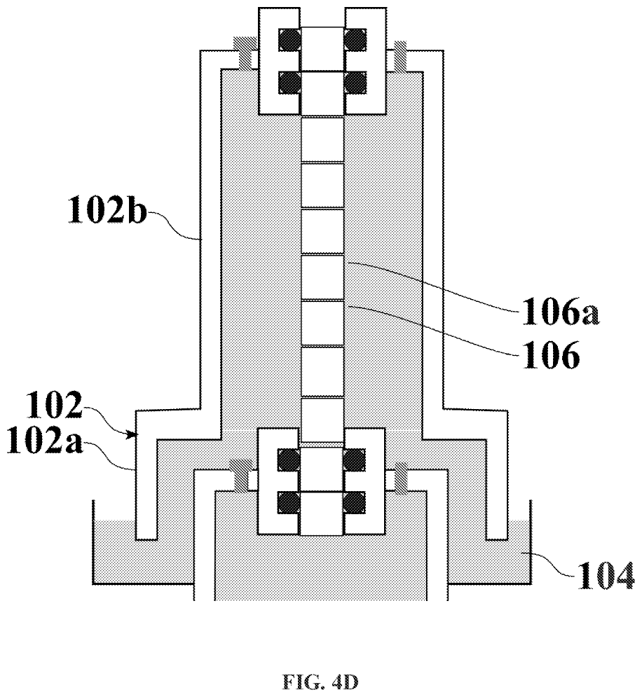

The process of priming can be achieved by two different ways, which are described herein with reference to FIG. 4A, FIG. 4B, FIG. 4C, and FIG. 4D. Both are optional methods and any one method can be chosen.

In one embodiment a mechanical process for the priming of the apparatus 100 is disclosed. The mechanical priming process starts from the bottom most fluid chamber of the plurality of fluid stacked chambers 102 and has to be performed sequentially for each of the immediately above fluid chamber of the plurality of fluid stacked chambers 102.

In another embodiment, the priming process can be carried out electronically. In this electronic priming process, the various outlets are controlled electronically. In other words, the various outlets of the plurality of stacked fluid chambers is performed electronically. The opening and closing of the outlets are controlled in an automatic manner and may be also performed by a pre-programmed processor or the like. The electronic priming process since being automated is simple, and priming can be achieved in one single shot.

The priming process, whether mechanical or electronic, the steps or procedure remains broadly the same, and is described herein below.

In accordance with the embodiments of the present invention, the priming process in the bottom most fluid chamber is illustrated in FIG. 4A, and FIG. 4B. Further, the priming process in the other fluid chambers disposed above the bottom most fluid chambers is illustrated in FIG. 4C, and FIG. 4D.

There are few things that needs to be taken into consideration before priming of the plurality of stacked fluid chambers. All of the plurality of stacked fluid chambers is pre-filled with the buoyant mass 106. In accordance with the embodiment of the present invention, if not all, at least the buoyant masses 106 are placed in the isolator 110. Rest of the buoyant masses 106 may be disposed within the plurality of stacked fluid chambers 106 after the fluid priming process.

The mechanical priming is now described while referring to FIG. 4A, and FIG. 4B. The fluid container 102a is filled with the fluid (which may be water), wherein the vertical level of which is higher than bottom of the fluid retaining tube 102b.

The bottom face of the fluid retaining tube 102b is temporarily closed using a suitable lid 113 and seal (as illustrated in FIG. 4A) to prevent of leakage of the fluid.

In accordance with the present invention, a threaded bleed screw with a seal is provided on top left corner of the fluid retaining tube 102b, wherein the threaded bleed screw facilitates in venting out the air trapped inside the fluid retaining tube 102b.

In accordance with the present invention, a port plug is configured on the top right corner of the fluid retaining tube 102b which is opened and the fluid is filled in therethrough. In one embodiment piping arrangement can be made for passage of the fluid (not shown in the figures). In accordance with one embodiment, the port plug can be of any shape or design like stop valve, flow control valve, butterfly valve or just an externally threaded plug with sealing arrangement to avoid fluid leakage.

While the fluid retaining tube 102b is being completely filled with fluid progressively, the threaded bleed screw with the seal facilitates in escape of the air trapped in the fluid retaining tube 102b such that inside of the fluid retaining tube 102b finally gets filled in by the fluid.

After fluid filling, the top openings of the fluid retaining tube 102b are closed and tighten by the threaded bleed screw with seal, and the port plug. Further, the bottom lid is opened or removed from the bottom of the fluid retaining tube 102b and is placed in a non-functional area like the bottom of the container 102a or is removed totally. Thus, the priming process is established. In case of mechanical priming, care is taken to start the priming process from the bottom chamber first followed by others in vertical sequence one after the other.

The electronic priming is now described while referring to FIG. 4C, and FIG. 4D. All the components illustrated in FIG. 4C and FIG. 4D are similar to those illustrated in FIG. 4A and FIG. 4B except for slightly differently shaped objects over here. Also, the priming process is same as explained with reference to the FIG. 4A and FIG. 4B.

In accordance with one embodiment the energy of the buoyant elevation of the mass can be used to generate electricity by free fall of the plurality of stacked buoyant masses 106 in air. That is the stacked buoyant masses 106 so elevated to a height can be allowed to fall freely, wherein the kinetic energy during the free fall can be captured and converted to electricity.

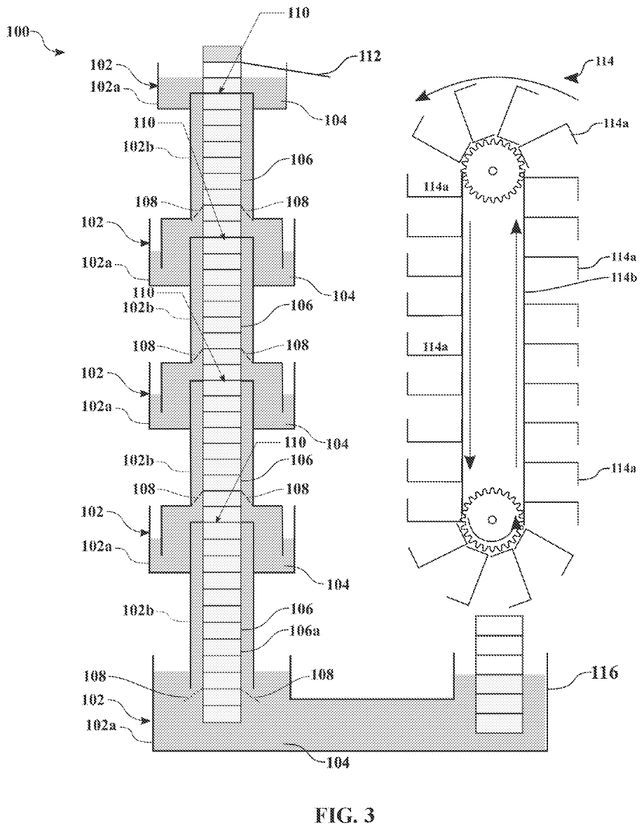

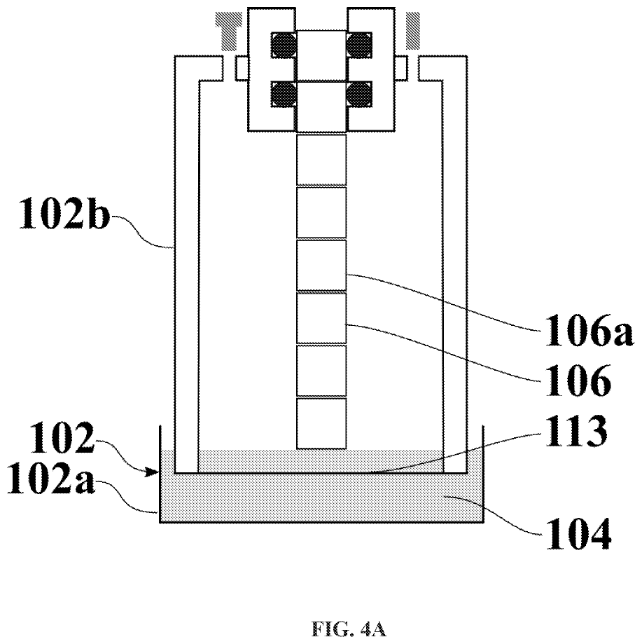

FIG. 3 illustrates a schematic diagram of an apparatus for buoyant elevation of mass for generating electricity in accordance with the embodiments of the present disclosure. More specifically, the apparatus 100 further includes a slant bed 112 operatively disposed between an operative top end of the plurality of stacked fluid chambers 102 and an electricity generation unit 114, wherein at least one of the plurality of stacked buoyant masses 106 received from the operative top end of the plurality of stacked fluid chambers 102 is gravity fed over the slant bed 112. After passage through slant bed kinetic energy level drops to kinetic energy scale 9. Further the buoyant masses 106 pass through the electricity generation unit 114 which is configured to generate an electric power. After passage through the electricity generation unit 114, most of the Kinetic energy of the buoyant mass 106 is absorbed by the electricity generation unit 114, thereby drop in the kinetic energy level of the buoyant mass to 1.

The residual kinetic energy (level 1), which is at bottom of the electricity generator unit 114 conveyor a buoyant holder/magazine 116 coupled to a transfer mechanism is placed, wherein the buoyant holder is configured to receive the buoyant mass 106 at the kinetic energy level-1 (AIR media) and pass on to fluid media so as to finally reach the fluid chamber bottom. The plurality of stacked buoyant masses 106 are subjected to work in a closed loop cycle for continued harnessing of useful electricity for humankind.

In accordance with an embodiment, the electric generation unit 114 comprises a buoyant holder 114a is coupled to a transfer mechanism 114b. The buoyant holder 114a is configured to receive the at least one of the plurality of stacked buoyant masses 106, which are at third kinetic energy level and move or displace the transfer mechanism 114b to generate an electric power. More specifically, the plurality of stacked buoyant masses 106 transfer most of the kinetic energy thereof to the transfer mechanism 114b thereby displacing the transfer mechanism, which in turn is connected to a dynamo or electric generator, which is cranked by the transfer mechanism 114b to generate electricity.

In one embodiment, the transfer mechanism 114b is a conveyor belt, and the conveyor belt further comprises a gear unit that is configured to rotate based on the movement of the conveyor belt, wherein the gear unit is coupled with a generator unit that is configured generate the electric power based on the rotation of the gear unit. The frequency of the electricity generated can be 50 Hz or 60 Hz, which can be tuned using the gear unit of appropriate size.

In another aspect, a method is disclosed using the apparatus 100 as described herein above. The method includes the steps of disposing a plurality of stacked fluid chambers 102, filling each of the plurality of stacked fluid chambers 102 with a fluid 104, wherein each of the plurality of stacked fluid chambers 102 is configured to displace the plurality of buoyant masses 106 from at least one chamber of the plurality of stacked fluid chambers 102 to other chambers of the plurality of stacked fluid chambers.

Further, a plurality of stacked buoyant masses 106 are disposed in the least one chamber of the plurality of stacked fluid chambers 102, wherein the at least one of the plurality of stacked buoyant masses 106 is configured to move from the at least one chamber of the plurality of stacked fluid chambers 102 to the other chambers of the plurality of stacked fluid chambers 102, through the fluid, wherein, in an operative configuration when activated, the at least one of the plurality of stacked buoyant masses 106 is up lifted with a first kinetic energy from the at least one chamber of the plurality of stacked fluid chambers, and the up lifted at least one of the plurality of stacked buoyant masses 106 reach the other chambers of the plurality of stacked fluid chambers 102 at a second kinetic energy, wherein the second kinetic energy is higher than the first kinetic energy.

### EXAMPLE

The following is an example in accordance with the embodiments of the present disclosure and is intended for better understanding of the present disclosure and not for limiting the scope thereof. Further, the example described herein is intended merely to facilitate an understanding of ways in which the embodiments herein may be practiced and to further enable those of skill in the art to practice the embodiments herein. Accordingly, the example should not be construed as limiting the scope of the embodiments herein.

In an operative configuration, a plurality of stacked fluid chambers 102 are disposed one above another in tandem and are filled with fluid. Each of the chambers of the plurality of stacked fluid chambers 102 have a height of approximately 9 metres. A total of four chambers were included, thereby the total height of the plurality of stacked fluid chambers 102 was 36 metres.

Buoyant masses 106 were then passed through the plurality of stacked fluid chambers 102. The diameter of the buoyant masses 106 is less than the inner diameter of the plurality of stacked fluid chambers 102, such that the fluid freely passes in diametrical gap between the buoyant masses 106 and the fluid chamber 102. In the present example, the diameter of the buoyant masses 106 was 200 mm, which was less than the diameter of the plurality of stacked fluid chambers 102, which as 250 mm.

The specific gravity of the buoyant masses 106 was chosen to be 0.99, which is less than the specific gravity of water (the fluid used). The effective specific gravity of the buoyant masses 106 is reduced to 0.60 to negate and make the buoyant masses 106 completely free from atmospheric pressure and also have small amount of upward buoyancy so as to completely rule out downward forces including fluid drag. Due to buoyancy, the buoyant masses 106 are pushed upward, and one upon inserting one buoyant mass 106 from below (the lowest chamber), one buoyant mass 106 is pushed out from top.

Thereafter, the buoyant masses 106 were allowed to slide over the slant bed 112 on to electricity generation unit 114 for generating electricity. Upon reaching the bottom of the electricity generation unit 114, that is upon generating electricity, the buoyant masses 106 have least kinetic energy and on the scale of 0 to 10, the kinetic energy of the buoyant masses 106 is 1, wherein the buoyant masses 106 are received by the magazine 116. Again, at the bottom of the plurality of the stacked fluid chambers 102, the kinetic energy of the buoyant masses 106 is at scale 0.

Further, on a scale of 0 to 10, the buoyant masses can be attributed kinetic energy as follows: a) when the buoyant masses are at the bottom of the plurality of the stacked fluid chambers 102, the kinetic energy is 0 (referred to as scale 0). When the buoyant masses 106 are at top of the stacked fluid chambers 102, the kinetic energy is 10 (referred to as scale 10).

The embodiments herein and the various features and advantageous details thereof have been explained with reference to the non-limiting embodiments.

The foregoing description of the specific embodiments have been described herein above that a person having ordinary skill in the art can apply the current knowledge, readily modify, or adapt for various applications such specific embodiments without departing from the generic concept. All such adaptations and modifications are intended to be comprehended within the meaning and range of equivalents of the disclosed embodiments.

Further, it is to be understood that the terminology employed herein is for the purpose of description and not of limitation. Therefore, while the embodiments herein have been described in terms of preferred embodiments, a person having ordinary skill in the art will readily recognize that the embodiments herein can be practiced with modification within the spirit and scope of the embodiments as described herein.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles, or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

What is claimed is:

1. An apparatus comprising:
a plurality of stacked fluid chambers, wherein each of the plurality of stacked fluid chambers is pre-filed with a fluid, the fluid is configured to displace a plurality of stacked buoyant masses from at least one chamber of the plurality of stacked fluid chambers to other chambers of the plurality of stacked fluid chamber; and
wherein the plurality of stacked buoyant masses is configured to move in an operative upward direction passing through the plurality of stacked fluid chambers;
wherein in an operative configuration when the apparatus is fully primed and activated, the bottom most buoyant mass of the plurality of stacked buoyant masses, which being at zero kinetic energy level, is lifted up at least by a height of one buoyant mass; and further the top most buoyant mass of the plurality of stacked buoyant masses is lifted up by a height of one buoyant mass with a kinetic energy level of ten.

2. The apparatus according to claim 1, wherein the plurality of stacked buoyant masses being displaced by the fluid contained within the plurality of stacked fluid chambers based on an atmospheric pressure acting on the fluid.

3. The apparatus according to claim 1, wherein each of the plurality of stacked fluid chambers are vertically arranged one above the other, wherein a first chamber is disposed at a first altitude level, and a second chamber is disposed at a second altitude level, the second altitude being higher than the first altitude.

4. The apparatus according to claim 3, wherein the at least one of the plurality of stacked buoyant masses is configured to move from the first altitude level to the second altitude level, wherein the first altitude level corresponding to a lower kinetic energy level, and the second altitude corresponding to a higher kinetic energy level.

5. The apparatus according to claim 1, wherein the plurality of stacked buoyant masses is gravity ted over a slant bed to an electricity generation unit to generate electric power, the plurality of stacked buoyant masses being at kinetic energy level nine at the electricity generation unit.

6. The apparatus according to claim 5, wherein upon generation of the electric power, the plurality of buoyant masses which being at kinetic energy level one, which being fed to the bottom of the plurality of stacked fluid chambers, and wherein upon being received to the bottom of the plurality of stacked fluid chambers, the plurality of buoyant masses is at kinetic energy level zero.

7. The apparatus according to claim 1, is primed by one of the process choses from mechanical priming or electronic priming, and wherein the process of priming includes the following steps:
pre-filling the plurality of stacked fluid chambers with the buoyant mass, or at least the buoyant masses are placed in an isolator, while rest of the buoyant masses being disposed within the plurality of stacked fluid chambers after fluid priming;
filling a fluid container with the fluid, wherein the vertical level of which is higher than bottom of a fluid retaining tube;
closing a bottom face of the fluid retaining tube temporarily using a lid and seal to prevent of leakage of fluid;
fixing a threaded bleed screw with seal on top left corner of the fluid retaining tube, wherein the threaded bleed screw facilitates in venting out the air trapped inside the fluid retaining tube;
a port plug is provided on the top right corner of the fluid retaining tube which is opened and the fluid is filled in therethrough;
filling the fluid retaining tube completely with fluid; and
closing the threaded bleed screw with seal, and the port plug and opening the bottom lid, which establishes the priming process.

8. The apparatus according to claim 5, wherein the electricity generation unit comprises a buoyant holder coupled to a transfer mechanism, the buoyant holder is configured to receive the plurality of stacked buoyant masses at kinetic energy level nine, and move the transfer mechanism to generate electricity.

9. The apparatus according to claim 8, wherein the transfer mechanism is a conveyor belt comprising a gear unit configured to rotate based on the movement of the conveyor belt, the gear coupled with a generator unit configured to generate the electric power based on the rotation of the gear unit.

10. A method, comprising:
disposing a plurality of stacked fluid chambers;
filling each of the plurality of stacked fluid chambers with a displaceable fluid, wherein each of the plurality of stacked fluid chambers is configured to displace the displaceable fluid from at least one chamber of the plurality of stacked fluid chambers to other chambers of the plurality of stacked fluid chambers;
disposing a plurality of stacked buoyant masses in the at least one chamber of the plurality of stacked fluid chambers, wherein the at least one of the plurality of stacked buoyant masses is configured to move upwards from the at least one chamber of the plurality of stacked fluid chambers to the other chambers of the plurality of stacked fluid chambers, through the displaceable fluid,
wherein, when activated, the at least one of the plurality of stacked buoyant masses is pumped with a first kinetic enemy from the at least one chamber of the plurality of stacked fluid chambers, and the pumped at least one of the plurality of stacked buoyant masses reaches the other chambers of the plurality of stacked fluid chambers at a second kinetic energy, wherein the second kinetic energy is higher than the first kinetic energy, wherein the second kinetic energy is at scale 10, and the first kinetic energy is at scale 0.
